(19) United States
(12) Patent Application Publication
(10) Pub. No.: US 2026/0252335 A1
(43) Pub. Date: Aug. 27, 2026

(54) INFORMATION HANDLING SYSTEM WITH A DYNAMIC CONFIGURATION RESILIENCY AWARE BASIC INPUT/OUTPUT SYSTEM UPDATE

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Amit K. Tiwari, Austin, TX (US)

(21) Appl. No.: 19/063,085

(22) Filed: Feb. 25, 2025

(51) Int. Cl. G06F 8/65

(52) U.S. Cl. CPC G06F 8/65

(57) ABSTRACT

An information handling system includes a system on a chip (SoC) and an embedded controller. The system receives a firmware update bundle, which includes benchmark update configurations and firmware updates for the information handling system. The SoC performs a firmware update process based on the firmware update bundle. In response to the firmware update process being successful, the information handling system restarts. Upon the restart of the information handling system, the SoC performs boot operations with the firmware updates and previous user configurations. During the firmware update process, the system stores the benchmark update configurations. The embedded controller monitors the boot operations of the SoC. In response to a failure of the boot operations, the system replaces the previous user configurations with the benchmark update configurations.

### FIELD OF THE DISCLOSURE

The present disclosure generally relates to information handling systems, and more particularly relates to an information handling system having a dynamic configuration resiliency aware basic input/output system update.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a system on a chip (SoC) and an embedded controller. The system may receive a firmware update bundle, which includes benchmark update configurations and firmware updates for the information handling system. The SoC may perform a firmware update process based on the firmware update bundle. In response to the firmware update process being successful, the information handling system may restart. Upon the restart of the information handling system, the SoC may perform boot operations with the firmware updates and previous user configurations. During the firmware update process, the system may store the benchmark update configurations. The embedded controller may monitor the boot operations of the SoC. In response to a failure of the boot operations, the system may replace the previous user configurations with the benchmark update configurations.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of an information handling system according to at least one embodiment of the present disclosure;

FIG. 2 is a flow diagram of a method for performing a firmware update based on benchmark configuration data according to at least one embodiment of the present disclosure;

FIG. 3 is a flow diagram of a method for replacing configuration data for firmware with a benchmark update configuration after a boot failure according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

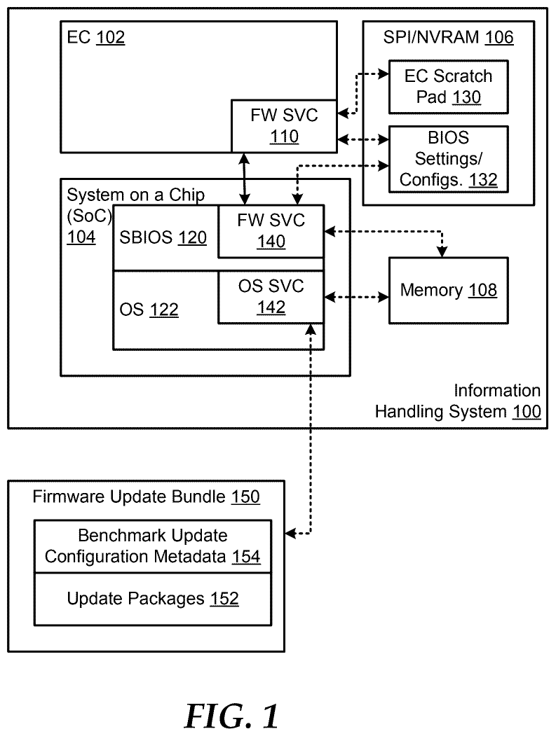

FIG. 1 illustrates a portion of an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes an embedded controller 102, a system on a chip (SoC) 104, a storage 106, and a memory 208. In an example, storage device 128 may be any suitable type of storage device, such as a serial peripheral interface/non-volatile random access memory (SPI/NVRAM) or the like. Embedded controller 102 includes a firmware service 110. In an example, firmware service 110 may be a driver to enable communication between embedded controller 102 and SoC 104 and between embedded controller 102 and storage 106. SoC 104 includes a system basic input/output system (SBIOS) 120 and an operating system (OS) 122. Storage 106 may be divided into different storage locations including, but not limited to, an embedded controller scratch pad 130 and BIOS, settings, and configurations location 132. SoC 104 includes different services, such as firmware service 140 and OS service 142. Information handling system 100 may include additional components without varying from the scope of this disclosure.

During operations of information handling system 100, SoC 104 may receive a firmware update bundle 150. In certain situations, the firmware update may not be compatible with the current BIOS settings and configurations of information handling system 100. In previous information handling systems, if the firmware update is not compatible with the current BIOS settings and configurations, the information handling systems may not boot after the firmware update has been completed. In this situation, the previous information handling system may enter a no post/no video (NP/NV) situation. Information handling system 100 may be improved by embedded controller 102 monitoring boot operations of SoC 104. In response to a detection of a boot failure, the embedded controller may bring information handling system 100 to a known boot state and notify the user for the confirmation to apply the changed settings.

In an example, firmware update bundle 150 may include an update package 152 and metadata 154 associated with the update package. In certain examples, firmware update bundle 150 may be in an executable format, such as BIOSUpdate. exe, which OS 122 may utilize to perform the firmware updates. In an example, update package 152 may include a new firmware or firmware updates for information handling system 100, and metadata 154 may include benchmark update configurations for the firmware updates. Benchmark update configurations 154 may include BIOS settings, critical BIOS configurations other than settings, boot sequences, or the like. In an example, benchmark update configurations may manifest with user configurable default BIOS settings plus other non-configurable/non-visible configurations. These settings and configurations may have been successfully tested with the firmware updates prior to the release of the firmware update bundle 150.

When a new BIOS update is available on information handling system 100, firmware update bundle 150 may be executed by OS 122 of SoC 104. For example, OS service 142 may extract update package 152 and benchmark update configurations 154 from the update bundle 150. In response to the update package 152 and benchmark update configurations 154 being extracted, OS service 142 may store the firmware update and the benchmark update configurations in memory 108. In certain examples, the storage of firmware update 152 and benchmark update configurations 154 in memory 108 may be performed in any suitable manner such as any existing BIOS update process. After the BIOS update process is completed, SoC 104 may restart information handling system 100 to boot into UEFI update mode.

In UEFI update mode, firmware service 140 of SBIOS 120 may fetch or retrieve benchmark update configurations 154 from memory 108 and send to embedded controller 102. In response to receiving the benchmark update configurations 154, embedded controller 102 may store the configurations as backup in temporary storage 130 of storage 106. After benchmark update configurations 154 are stored in temporary storage 130, SBIOS 120 may proceed with a regular BIOS update. In response to the BIOS update being successful, SoC 104 may reset once again to boot with the new firmware from the BIOS update. In an example, this boot operation may be performed using the previous user configurations. In certain examples, embedded controller 102 may monitor the boot operations of SoC 104. For example, embedded controller 102 may utilize firmware service 110 as a boot tracking mechanism to monitor the boot operations of SoC 104. If SoC 104 successfully boots to OS 122, embedded controller 102 may clear benchmark update configurations 154 from temporary storage 130 of storage 106. After clearing the benchmark update configurations 154, SoC 104 may operate OS 122.

If SoC 104 failed to boot immediately after the firmware update, embedded controller 102 may detect the boot failure. In response to the boot failure, embedded controller may replace the user previous configurations with benchmark update configurations 154 in memory location 132 of the storage and a store copy of previous BIOS configuration settings in another location of storage 106. On reboot, SoC 104 may perform the boot operation with benchmark update configurations 154 now stored in storage location 132. As described above, benchmark update configurations 154 are proven configurations that work with the new/updated firmware. On successful boot to OS 122, an individual associated with information handling system 100 may be provided with a notification that a change in the boot configurations have occurred. In an example, the user may be asked to confirm these changes to the BIOS settings and configurations. In response to the confirmation, embedded controller 102 may delete the copy of the previous user configurations. Thus, embedded controller 102 and SoC 104 may combine to provide auto-recover of information handling system 100 from a POST/boot failure state with the resiliency of trusted benchmark update BIOS configurations 154.

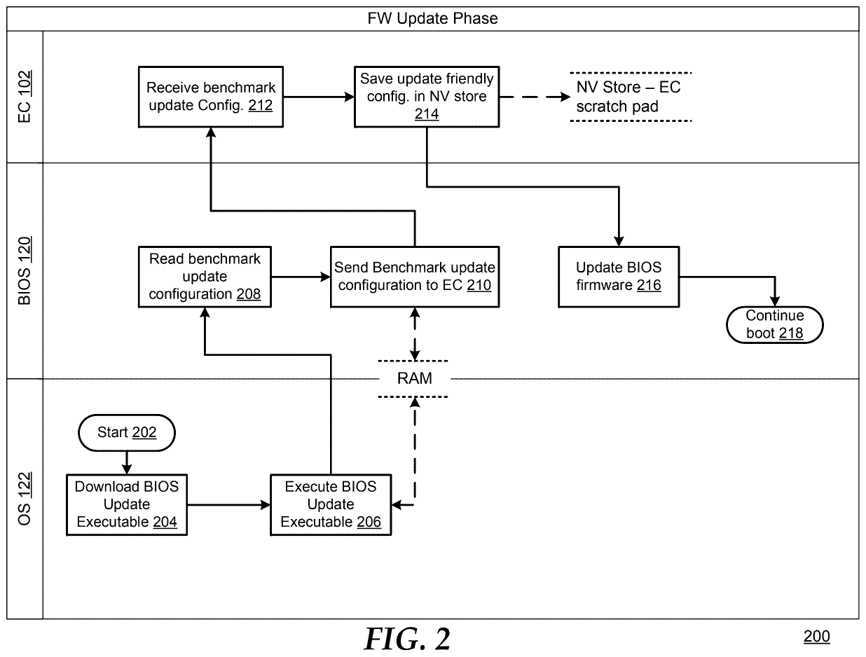

FIG. 2 shows a method 200 for performing a firmware update based on benchmark configuration data according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, embedded controller 102 of information handling system 100 and SoC 104 of information handling system 100 in FIG. 1, or any other type of controller, device, module, processor, or any combination thereof, operable to employ all, or portions of, the method of FIG. 2.

At block 204, a firmware update bundle file is downloaded. In an example, the firmware update bundle file may be downloaded by a SoC of the information handling system while the SoC is executing an OS. In an example, the firmware update bundle file may be any suitable updateable firmware update bundle in the form of . exe, such as BIOSUpdate. exe. The firmware update bundle may include new firmware or an update to the existing firmware of the information handling system. The firmware update bundle may include benchmark update configurations, which may include, but are not limited to, BIOS settings, critical BIOS configurations other than settings, and a boot sequence. Additionally, the benchmark update configurations may user configurable default BIOS settings plus other non-configurable or non-visible configurations and these configurations may have been successfully tested with the new BIOS update payload for each client system.

At block 206, the firmware update bundle is executed. In an example, the execution of the firmware update bundle may include extracting the firmware update package and any metadata associated with the update package. The metadata in the firmware update bundle may include the benchmark update configurations for the firmware in the update package. In certain examples, the benchmark configurations may be stored in a RAM storage accessible by both an OS of the SoC and a BIOS of the SoC.

At block 208, the benchmark update configurations are read. At block 210, the benchmark update configurations are sent to the embedded controller. In an example, a firmware service in the BIOS of the SoC may be utilized to send the benchmark configurations to the embedded controller. For example, the firmware service may retrieve the benchmark configurations from the RAM and provide the update configurations to the embedded controller via the firmware service of the embedded controller.

At block 212, the benchmark update configurations are stored in a non-volatile storage device. In an example, the benchmark update configurations may be stored in a specific area of the non-volatile storage designated for the embedded controller. For example, the specific area may be defined as a scratch pad for the embedded controller.

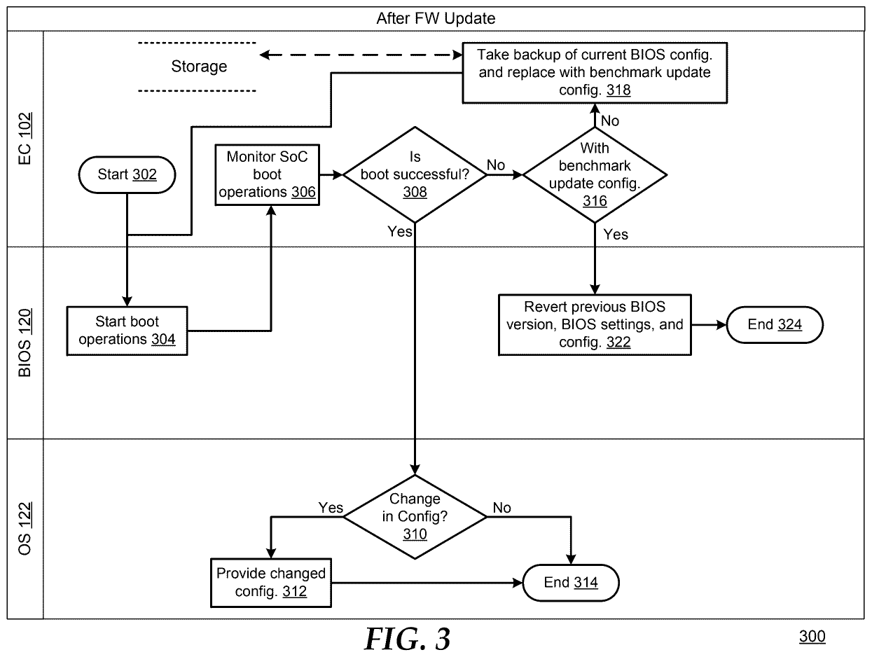

At block 214, the BIOS firmware is updated and the next boot operation is started at block 216. In an example, the BIOS firmware is updated with the new firmware in the update package of the firmware update bundle. In certain examples, the next boot operation is performed after a reset of the information handling system by the embedded controller. The immediate next boot operation generated by the reset will be described with respect to FIG. 3.

FIG. 3 shows a method 300 for replacing configuration data for firmware with a benchmark update configuration after a boot failure according to at least one embodiment of the present disclosure, starting at block 302. Not every method step set forth in this flow diagram is always necessary, and certain steps of the methods may be combined, performed simultaneously, in a different order, or perhaps omitted, without varying from the scope of the disclosure. FIG. 3 may be employed in whole, or in part, embedded controller 102 of information handling system 100 and SoC 104 of information handling system 100 in FIG. 1, or any other type of controller, device, module, processor, or any combination thereof, operable to employ all, or portions of, the method of FIG. 3.

At block 304, BIOS boot operations are started. In an example, the boot operations are started or triggered in response to a restart of the information handling system. The boot operations may be performed by BIOS 120 of an SoC in the information handling system. At block 306, the boot operations are monitored. In an example, the boot operations of the BIOS in the SoC may be monitored by the embedded controller of the information handling system. For example, a firmware service of the embedded controller may communication with the BIOS of the SoC and monitor the boot operations.

At block 308, a determination is made whether the boot is successful. This determination is performed by embedded controller 102 while monitoring the boot operations. If the boot operations are successful, a determination is made whether a BIOS configuration change has occurred at block 310. In an example, the configuration change may result from the boot operations utilizing benchmark configurations instead of the previous BIOS configurations of the BIOS 120. If the configuration has changed, a user is provided with a notification of the configuration change at block 312 and the flow ends at block 314. If the configuration has not changed, the flow ends at block 314.

If, at block 308, the boot is not successful, a determination is made whether the boot operations were performed using the benchmark configurations at block 316. If the boot operations were not performed with the benchmark configurations, the backup of the current BIOS configurations is created and the current BIOS configurations are replaced with the benchmark update configurations at block 318 and the flow continues as described above at block 304.

In an example, the backup of the current BIOS configurations are stored in one location of the non-volatile storage and the current BIOS configurations are replaced with the benchmark update configurations in another location of the non-volatile storage. The location in the storage where the BIOS configurations are replaced with the benchmark configurations is accessibly by the BIOS of the SoC. If the boot operations were performed with the benchmark update configurations, the firmware version, settings and configurations are reverted to the previous BIOS version, BIOS settings, and BIOS configurations at block 322 and the flow ends at block 324.

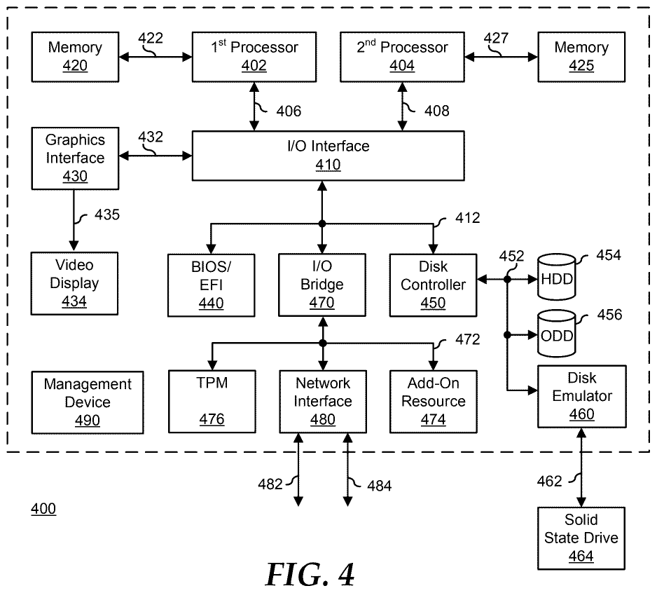

FIG. 4 shows a generalized embodiment of an information handling system 400 according to an embodiment of the present disclosure. Information handling system 400 may be substantially similar to information handling system 100 of FIG. 1. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a system on a chip (SoC) to:
receive a firmware update bundle, wherein the firmware update bundle includes benchmark update configurations and firmware updates for the information handling system;
perform a firmware update process based on the firmware update bundle;
in response to the firmware update process being successful, restart the information handling system; and
upon the restart of the information handling system, perform boot operations with the firmware updates and previous user configurations; and
an embedded controller to communicate with the SoC, the embedded controller to:
during the firmware update process, store the benchmark update configurations;
monitor the boot operations of the SoC; and
in response to a failure of the boot operations, replace the previous user configurations with the benchmark update configurations.

2. The information handling system of claim 1, wherein in response to the replacement of the previous user configurations with the benchmark update configurations, the SoC further to:
restart the information handling system; and
upon the restart of the information handling system, perform the boot operations with the firmware updates and benchmark update configurations.

3. The information handling system of claim 2, wherein in response to the boot operations being successful with the benchmark update configurations, the SoC further to: provide a prompt to a user to confirm a change from the previous user configurations to the benchmark update configurations.

4. The information handling system of claim 3, in response to a reception of a confirmation, the embedded controller further to: delete a copy of the previous user configurations.

5. The information handling system of claim 1, wherein in response to a success of the boot operations with the firmware updates with the previous user configurations, the embedded controller further to: delete the benchmark update configurations.

6. The information handling system of claim 1, in response to the failure of the boot operations to the firmware updates, the embedded controller further to: store a copy of the previous user configurations prior to the replacement of the previous user configuration with the benchmark update configurations.

7. The information handling system of claim 1, wherein the benchmark update configurations include basic input/output system settings and configurations successfully tested with the firmware updates.

8. The information handling system of claim 1, wherein the boot operations with the firmware updates with the previous user configurations is immediately following the firmware update process.

9. A method comprising:
receiving, by a system on a chip (SoC) of an information handling system, a firmware update bundle, wherein the firmware update bundle includes benchmark update configurations and firmware updates for the information handling system;
performing a firmware update process based on the firmware update bundle;
during the firmware update process, storing, by an embedded controller of the information handling system, the benchmark update configurations;
in response to the firmware update process being successful, restarting the information handling system;
upon the restart of the information handling system, performing boot operations with the firmware updates and previous user configurations;
monitoring, by the embedded controller, the boot operations of the SoC; and
in response to a failure of the boot operations, replacing the previous user configurations with the benchmark update configurations.

10. The method of claim 9, wherein in response to the replacing of the previous user configurations with the benchmark update configurations, the method further comprising:
restarting the information handling system; and
upon the restart of the information handling system, performing the boot operations with the firmware updates and benchmark update configurations.

11. The method of claim 10, wherein in response to the boot operations being successful with the benchmark update configurations, the method further comprises: providing a prompt to a user to confirm a change from the previous user configurations to the benchmark update configurations.

12. The method of claim 11, in response to a reception of a confirmation, the method further comprises: deleting a copy of the previous user configurations.

13. The method of claim 9, wherein in response to a success of the boot operations with the firmware updates with the previous user configurations, the method further comprises: deleting the benchmark update configurations.

14. The method of claim 9, in response to the failure of the boot operations to the firmware updates, the method further comprises: storing a copy of the previous user configurations prior to the replacing of the previous user configuration with the benchmark update configurations.

15. The method of claim 9, wherein the benchmark update configurations include basic input/output system settings and configurations successfully tested with the firmware updates.

16. The method of claim 9, wherein the boot operations with the firmware updates with the previous user configurations is immediately following the firmware update process.

17. A method comprising:
receiving, by a system on a chip (SoC) of an information handling system, a firmware update bundle, wherein the firmware update bundle includes benchmark update configurations and firmware updates for the information handling system;
performing a firmware update process based on the firmware update bundle;
during the firmware update process, storing, by an embedded controller of the information handling system, the benchmark update configurations;
in response to the firmware update process being successful, restarting the information handling system;
upon the restart of the information handling system, performing boot operations with the firmware updates and previous user configurations;
monitoring, by the embedded controller, the boot operations of the SoC;
in response to a success of the boot operations with the firmware updates with the previous user configurations, deleting the benchmark update configurations;
in response to a failure of the boot operations, replacing the previous user configurations with the benchmark update configurations;
restarting the information handling system; and
upon the restart of the information handling system, performing the boot operations with the firmware updates and benchmark update configurations.

18. The method of claim 17, wherein in response to the boot operations being successful with the benchmark update configurations, the method further comprises: providing a prompt to a user to confirm a change from the previous user configurations to the benchmark update configurations.

19. The method of claim 18, in response to a reception of a confirmation, the method further comprises: deleting a copy of the previous user configurations.

20. The method of claim 17, in response to the failure of the boot operations to the firmware updates, the method further comprises: storing a copy of the previous user configurations prior to the replacing of the previous user configuration with the benchmark update configurations.
